(19) United States
(12) Patent Application Publication
(10) Pub. No.: US 2013/0173202 A1
(43) Pub. Date: Jul. 4, 2013

(54) Systems and Methods for Dynamic Prognostication of Machine Conditions for Rotational Motive Equipment

(71) Applicant: AKTIEBOLAGET SKF, Goteborg (SE)

(72) Inventor: Johannes L. Boerhout, San Diego, CA (US)

(73) Assignee: AKTIEBOLAGET SKF, Goteborg (SE)

(21) Appl. No.: 13/731,712

(22) Filed: Dec. 31, 2012

Related U.S. Application Data
(60) Provisional application No. 61/582,162, filed on Dec. 30, 2011.

(51) Int. Cl. G06F 15/00

(52) U.S. Cl. CPC G06F 15/00
USPC 702/113

(57) ABSTRACT

Methods and systems for prognosticating high efficiency machine conditions, and testing thereof such as with machine condition assay agenda recommendations, sequenced machine condition assay schematic recommendations, a machine maintenance exigency prognosticator, or the like perhaps responsive to valued information indicia, extrinsic influential information, or the like.

This is the U.S. non-provisional patent application claiming the benefit of and priority to U.S. Provisional Application No. 61/582,162, filed Dec. 30, 2011, hereby incorporated by reference herein.

### FIELD OF THE INVENTION

The present invention generally relates to systems and methods for monitoring the condition of a machine or plurality of machines. More particularly, the present invention concerns systems and methods for analysis and prognostication of performance characteristics of machines such as but not limited to electrical motors, rotational machines, non-rotational machines, and the like.

### BACKGROUND OF THE INVENTION

It is common for industrial and commercial facilities to operate a large number of machines such as electrical motors concurrently, many of which may cooperate in a large interdependent process or system. Despite increasingly efficient maintenance programs, at any time some percentage of the machines develop defects that are likely to lead to machine failure. For example, machines having moving parts (e.g., bearings) and experience constant friction that results in wear. It is known that bearing failures are a major cause of motor faults. Bearing damage due to wear may not be apparent absent gross damage or failure of the motor, however, because the bearing's wear site is likely concealed in the motor's assembled state.

Consequently, the use of machine condition monitoring systems has become essential to preventive maintenance of industrial machinery in order to avoid down time or catastrophic failure of machines. Unscheduled plant shutdowns can result in considerable financial losses. Failure of high performance machinery can lead to fatal injury and processing system backup. Typical benefits from a preventive maintenance program include longer periods between machinery shutdowns, evaluation of the condition of machine components without resorting to costly and/or destructive disassembly for visual inspection, and prolonging the machinery's operational life by taking corrective action when developing faults are identified early.

Measurement and analysis of machine vibrations typically includes sensing the machine's vibrations with a transducer that converts the vibration information to electrical signals. The electrical signals are processed so that a history of vibration amplitude over time can be obtained. Data points representing amplitude at a certain point in time may be plotted on a graph of amplitude versus time. This graph is often referred to as the time-domain vibration signature of the machine. FIG. 1 shows an exemplary graph of time-domain vibration data. FIG. 1 is a plot of measured acceleration of a point of a machine assembly over a period of about eight seconds. The particular machine from which this data was measured was rotating at 104.98 rpm, so FIG. 1 shows data over the course of about 15 revolutions. Peak values measured were about 0.025 g.

Rotating and reciprocating components of a machine produce vibrations having a wide range of frequencies. In addition to the time-domain data representation of machine vibrations, the vibrations of a machine, machine component, or other phenomena acting on the machine may be characterized by a plot of vibration energy as a function of vibration frequency. This diagram is commonly referred to as a “frequency spectrum,” “spectral diagram,” or “spectrum plot.” FIG. 2 shows an exemplary frequency spectrum, which was derived from the time-domain vibration data of FIG. 1. Although the frequency scale is not illustrated in FIG. 2, prominent peaks are seen at about 10-11 Hz (designated as peak 10) and about 87 Hz (designated as peak 20).

The frequencies and associated peaks of the vibrations of a specific machine collectively make up the “frequency spectrum” for the machine, also known as the machine's “vibration signature.” A machine's vibration signature varies with, for example, the design, manufacture, application, and wear of its components. The machine's normal operating conditions can determine the amplitude of steady (or “normal”) vibration. It is a common practice to obtain a reference frequency spectrum when the machine is known to be in good condition for comparison against future measurements of the machine's frequency spectrum. Such comparison aids in detecting changes in the condition of the machine or its subcomponents. Hence, analysis of a machine's vibration signature provides valuable insights into the condition of the machine.

The present invention is directed to improvements to a standard machine monitoring system to provide a prognostication system of one or more performance characteristics of a machine or machines. Monitoring systems may include one or more sensors mounted on the machine and configured to measure a performance characteristic of the machine, such as vibration, temperature, pressure, etc. and as discussed in U.S. Pat. No. 7,289,919 to Boerhout hereby incorporated by reference in its entirety. Often, each machine has multiple sensors mounted at various locations on the machine, which may all be of the same type or different types. When different types of sensors are employed, each sensor type may use a measurement technique that differs from the other sensor types.

Further, the sensors may send data continuously to a connected central processing unit (i.e., hard-wired or wireless) or may periodically transmit data to a hand-held measuring device that is temporarily connected with the sensors. Such a hand-held unit may process the data to provide performance information (e.g., vibration level) directly to a user or may merely store the data for subsequent transfer to a separate processing device.

To ensure that all the machines at a particular location (e.g., a factory, a pipeline system) are monitored on a periodic basis, one or more operators are sometimes provided with a fixed list of machines from which vibration measurements are to be taken at particular dates or time intervals. Such a list is referred to as a “route” and is generally fixed for a particular location. In other words, the route has the operator check specific machines on fixed days and repeats the process on a fixed periodic basis. For example, an operator may take sensor data from a particular machine every other Tuesday or on a particular day of the month.

There is a need to analyze machine performance data and forecast future performance levels to determine when a particular performance characteristic might exceed a predetermined level to perhaps provide an effective preventive maintenance program. The embodiments of the present invention address this need.

### SUMMARY OF THE INVENTION

In general, the present invention discloses methods and systems for monitoring, analyzing, and prognosticating performance characteristics of machine conditions. The present invention may utilize current performance data and, perhaps by applying statistical modeling techniques such as but not limited to curve-fitting of data, may forecast future performance levels to determine when a particular performance characteristic might exceed a predetermined maximum level (e.g., the “alarm level”).

An object of the present invention may include devices and methods for prognosticating performance levels based on calculations with data received from a sensor or machine to determine when a performance level may be predicted to exceed an alarm level. Devices may include hand-held measuring unit, processors or the like.

Another object of the present invention may include a fleet system where data may be combined from a plurality of sources and integrated in a prognosticate analysis.

Yet another object of the present invention may include a prognostication that gives a user additional mean time between failures (“MTBF”) type of data for a machine or plurality of machines being monitored.

Another object of the present invention may include a multiple sensor prognostication system and methods using multiple sensors to perhaps enhance prediction of the conditions of a machine or plurality of machines.

In yet another object, the present invention may include a curve fitting analysis for data received in determining a prognostication.

Another object of the present invention may integrate historical performance data in the analysis and determination of a prognostication.

Naturally, further objects of the invention are disclosed throughout other areas of the specification.

### BRIEF DESCRIPTION OF THE DRAWINGS

The following descriptions and referenced drawings are for selected embodiments of the present invention. Naturally, changes may be made to the disclosed embodiments while still falling within the scope and spirit of the present invention.

FIG. 1 is an example of a graph of a machine's time-domain vibration data before processing with the systems and methods of the invention.

FIG. 2 is an example of a graph of the frequency spectrum of the time-domain data of FIG. 1.

FIG. 3 is a block diagram of an exemplary system in accordance with the present invention for a prognostication system.

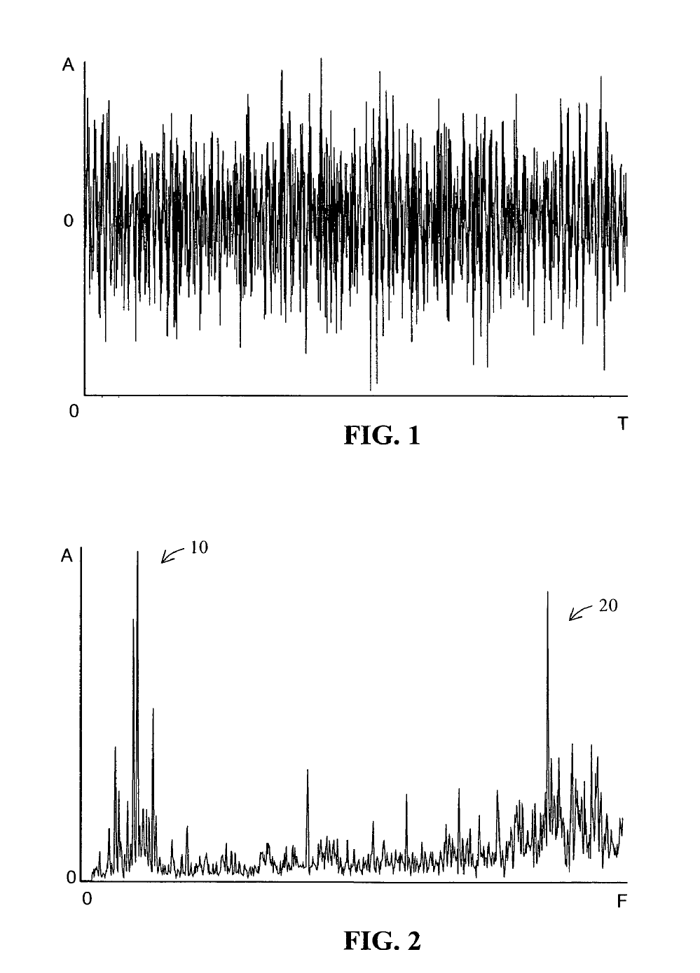

### DETAILED DESCRIPTION OF THE PREFERRED EMBODIMENTS

The present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

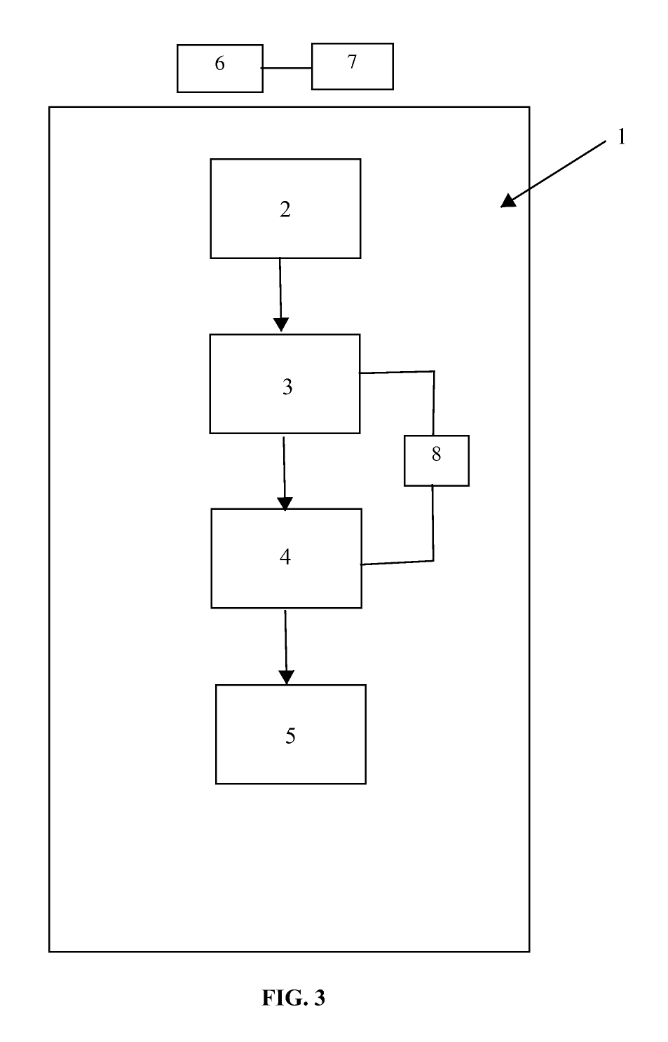

Embodiments of the present invention may include the prognostication of performance capabilities of a machine, group of machines, a plant system or the like by utilizing and even analyzing data. In a general sense, as may be understood from FIG. 3, an example of a prognostication system (1) may include a data input (2), a data transformation manipulation element (3), a prognosticated result element (4), and perhaps even a display or communication for a prognosticated result (5). Various recommendations or other prognosticated results or the like may be displayed or communicated on a screen display (5) or even a screen of a device or the like perhaps to alert a user. A prognostication result may include a determination of when a machine might reach a certain threshold, such as but not limited to, future performance levels, when a machine may need maintenance or adjustments, when to expect failure of a machine, when to expect a decrease in function of a machine, when unacceptable risk levels might occur, or the like. Other prognostication results may include reports, costs for machine failures, estimated costs, or the like.

In embodiments, the present invention may provide a prognostication system (1) such as a prognosticative high efficiency scheduling system of machine testing and methods thereof. A data input (2) may be a valued information indicia input, such as a rotational motive apparatus valued information indicia input, from a rotational motor apparatus (6) or any other kind of machine or the like. A rotational motor apparatus (6) may be interconnected with a plurality of rotational motor apparatuses or machines or the like and may even generate or otherwise provide valued information indicia (7). Non-limiting examples of a rotational motor apparatus may include but are not limited to a rotating pump, a rotating electric motor, a compressor, and a rotating fan or the like. In some embodiments, an apparatus may include a condenser or even other machines, perhaps even machines without rotational motors, or the like. Valued information indicia (7) may be received perhaps by a receiver or device. A data transformation manipulation element may be included in a device or perhaps even a sensor or machine which may provide a program, software, subroutines, or the like elements which may transform initial data into transformed data as discussed herein. A data transformation manipulation element (3) may be a programmed processor such as a programmed valued information transformation processor perhaps configured to provide transforming of valued information indicia. In response to processing by a programmed processor of valued information indicia, a prognosticated result element (4) such as a machine condition assay agenda recommendation, a rotational motive apparatus condition assay agenda recommendation, prognosticating machine maintenance exigency, or the like, may be recommended.

A rotational motive apparatus condition assay recommendation or other kind of recommendation may provide a machine testing frequency recommendation perhaps responsive to transformed valued information indicia. This may provide a testing frequency recommendation that may include a time, number of days, an increased frequency of testing, a decreased frequency of testing, any combination thereof, or the like for when to test a particular machine. As such, depending on what may be determined from a received information input, a prognostication result element may provide a machine testing agenda for an apparatus or even a plurality of apparatuses responsive to the input. A rotational motive apparatus condition assay agenda recommendation may provide a machine testing schedule recommendation for a machine such as a rotational motive apparatus. A schedule recommendation may provide machine testing or even a series of machine testing to be done or to occur at or during a particular time or period. In embodiments, the present invention may provide adjustment to a rotational motive apparatus condition assay agenda perhaps by an agenda adjustment recommendation which may be responsive to valued information indicia or even new valued information indicia. As such, a prognosticated result element (4) may be an agenda adjustment recommendation. A machine testing schedule may be adjusted perhaps based on new indicia received, extrinsically influential information, or the like.

In order to determine an agenda recommendation or other kind of prognosticated result (5), some embodiments of the present invention may provide that an agenda recommendation may be responsive to a machine alarm level (8). By responsive, as referred to in various embodiments, a step or element may somehow relate or may even react to another step or element and may be direct, indirect, ancillary, based on, based in part on, or the like. A machine condition forecaster, which may be part of a data transformation manipulation element (3) or even a prognosticated result element (5), may provide a prognostication of closeness of a machine condition to a machine alarm level. A machine alarm level may include but is not limited to: a predetermined maximum level for a machine performance characteristic, a machine threshold, a machine future performance level, machine maintenance, machine failure, decrease in machine function, unacceptable risk level, any combination thereof, or the like. A programmed processor may process valued information indicia responsive to a machine alarm level. This may include analyzing, comparing, processing, transforming, or the like of valued information indicia perhaps as related to a machine alarm level. Valued information indicia may be compared against a machine alarm level and perhaps it may be determined or even forecasted how close to the machine alarm level a machine may be. A programmed processor may also or even alternatively provide a data analyzer perhaps to provide analyzing of valued information indicia or even new valued information indicia while utilizing or even comparing data including but not limited to predetermined data, performance data, virtual data, historical data, time-domain vibration signature data, extrinsically influential information, curve fit data, any combination thereof, or the like.

A data input (2) may receive any type of data including but not limited to performance data, current data, virtual data, historical data, time-domain vibration signature data, or the like perhaps as obtained from a sensor, a plurality of sensors, a virtual sensor, a plurality of virtual sensors, a machine, a plurality of machines, a device, a plurality of devices, vibrations, machine vibrations, frequencies, machine frequencies, temperature, pressure, reported data, a signal, transmitted data, remotely transmitted data, wirelessly transmitted data, downloaded data, data received via connections, a database, any combination thereof, or the like. Non-limiting examples of valued information indicia may include but is not limited to sensor data, vibration measurements, frequency, frequency spectrum, current information, virtual sensor data, temperature, pressure, raw data, current data, virtual data, time-varying rotational indicia, time-domain vibration signature data, periodic indicia, dynamic load, speed, processed data, at least one valued information indicia, at least two valued information indicia, valued information indicia from at least one sensor, any combination thereof, or the like.

As mentioned herein, in analyzing data, a data transformation manipulation element (3) such as programmed valued information processor, a programmed processor, a transformation processor, or the like may be used. For example, a data transformation element may include but is not limited to statistical modeling technique, trend plot, linear display, curve fit, linear curve fit, exponential curve fit, empirical models, polynominal models, transformation into derived data, technical analysis, stochastic estimator, SAR, PSAR, output of statistic models, CUSUM function, smooth data, bringing out key artifacts, indicator script, trailing stop, sequential analysis techniques, machine specific trending, algorithms, trends, compression, any combination thereof or the like. In embodiments, data may be transformed by applying statistical modeling techniques such as but not limited to trend plots, linear display, curve fit, linear curve fit, exponential curve fit, empirical models, polynomial models, combinations thereof, or the like to perhaps provide a prognostication of future performance levels. Curve fitting may be the process of constructing a curve or mathematical function that has the best fit to a series of data points perhaps subject to constraints. It may involve interpolation where an exact fit to the data may be required or may involve smoothing where a function may be constructed that approximately fits the data or may even involve extrapolation where the use of a curve may go beyond a range of observed data. It may involve first degree, second degree, third degree, fourth degree, or higher polynomials, curves, constraints, equations or the like. It may even involve trigonometric functions (e.g., sine or cosine), conic sections, algebraic, geometric, or the like analysis. Raw data may be used with the data transformation such as for curve fitting or the like.

Alternatively, embodiments of the present invention may use data that has been first transformed into a derived data set before applying a curve fit or other data transformation manipulation element. Transformation of the data may include technical analysis or even stochastic estimators like the SAR, PSAR, or the like as well as output of statistic models such as formed from a CUSUM function or the like. A transformation may be aimed to smooth raw data or even bring out key artifacts that may enhance the forecast projection. This may include items or aspects such as an indicator script used to find trends and may be used as or include a trailing stop loss such as based on data tending to stay within a parabolic curve during a trend. In statistical quality control, the CUSUM (cumulative sum control chart) is one example of a sequential analysis technique perhaps used for monitoring change detection.

In embodiments a programmed processor may include a machine condition determinator, a machine condition evaluator, or even a machine condition forecaster to perhaps determine, evaluate, variably evaluate, or even forecast a machine condition or even a measurement forecast as discussed herein. A rotational motive apparatus condition assay agenda recommendation or other results may be responsive to a measurement forecast or the like.

A determination such as a prognosticated result element (4) may be calculated from analysis of the transformed data to provide information relative to when a particular performance characteristic may exceed a predetermined level such as but not limited to a maximum level, an alarm level, an alert, danger value, or the like. For example, a curve may be extended to cross an alarm level and the period between the last measurement and an alarm level may be measured in days. A predetermined level may be calculated based on history, data, algorithms, trends, machine specific trending, technical analysis, stochastic estimators, or the like.

A device for performing a prognostication system (1) such as a forecasting calculation or the like and that may receive input may include a portable device, a remote device, hand-held device, a processor, a specialized program downloaded onto a mobile device, a particularly configured computer, a specialized computer, a central processor, a central computer, a remote computer, a software system, microlog, marlin, pen, or the like. A receiver, which may be a device, may include but is not limited to a remote receiver, a wireless receiver, a download, a receiver with a connection, any combination thereof, or the like.

A prognosticated result element (4) such as a forecast calculation element may include or utilize a quantity “d” that may correspond with the number of days from the day on which the measurement is taken to the day on which the performance level may be predicted to exceed an alarm level. In embodiments, a particular machine or machines may have multiple sensors perhaps with a plurality of measurement techniques deployed on those sensors. A forecast expression could involve one or more curve fit functions whereby the values “d” computed for like sensor types and like measurement techniques may be combined by means of priority and averaging to arrive at a reported forecast value ‘D’ for an entire machine. Thus, a prognostication system performing forecasting calculations may not need to separately calculate a forecast quantity “d” based on data from each sensor. An overall forecast value “D” for an entire machine may be determined based perhaps on a weighted average of separate sensor forecast values “d”, perhaps with priority assigned to more critical components of the machine. A threshold value such as a value ‘D’ may be evaluated and defined from trends. The threshold value may be used to determine a report such as but not including a report of all the machines that have an alarm horizon of D less than about 14 days as but one example. Another example of a report includes a report of all machines that may have an alarm horizon that may be shorter than the predetermined measurement interval e.g., all machines that are expected theoretically to exceed an alarm set point before the next measurement sample may be taken.

In embodiments, the present invention may provide a prognostication system (1) such as a high efficiency machine prognostication valuation system where perhaps data input (2) may include valued information indicia and/or may even include extrinsic influential information input. A data transformation manipulation element (3) such as a data comparable programmed processor may be configured to compare valued information input with perhaps extrinsic influential information input to perhaps even provide a prognosticated result element (4) such as prognosticating machine maintenance exigency for rotational motive apparatuses. A machine maintenance exigency prognosticator may be a machine failure impact evaluator perhaps to evaluate an impact of machine failure responsive to extrinsically influential information or may even be a forecast calculation element such as a machine maintenance forecast value as discussed herein. In evaluation of an impact of machine failure responsive to extrinsically influential information, a low exigency for an apparatus or machine may be determined if an impact of machine failure may be low or perhaps even a high exigency for an apparatus or machine may be determined if an impact on machine failure may be high. Higher exigency may result in increased testing of a particular machine or recommended maintenance or the like. In embodiments, a prognosticated result element (4) such as a machine exigency prognosticator may provide a mean time between failure (MTBF) determination as further discussed herein. A machine exigency prognosticator may even provide a dynamic machine maintenance exigency prognosticator to perhaps provide dynamically prognosticating a machine maintenance exigency responsive to new information such as new indicia, new extrinsically influential information or the like.

Extrinsically influential information may be any kind of information that may relate to external or even outside factors to a machine being tested. For example, extrinsically influential information may include but is not limited to interconnected system information, factory information, an interconnected rotational motive apparatus effect information, an individual rotational motive apparatus effect information, failure effect information, time period information, calendar information, scheduling information, operator knowledge information, operator timeframe information, conservative threshold information, traditional threshold information, machine supplier information, machine type information, weather information, black out information, ability to check machines information, vacation information, ability to maintain a machine information, system value information, assembly line information, supply line information, entire factory information, entire process information, any combination thereof, or the like.

For systems monitored such as by hand-held devices, the data and/or forecast values can be combined from a plurality of sources, several sensors, from several machines, or perhaps even from several locations and may be integrated in a forecast analysis to provide a fleet system. Data integrated from a fleet system may be used to provide a forecast result based on the fleet information which may provide additional mean time between failures (MTBF) type data to a user, perhaps even if the user only has one machine that they are monitoring. In embodiments, historical performance data may integrate old data with a forecast analysis and conclusion.

As mentioned above, to ensure that all the machines at a particular location (e.g., a factory, a pipeline system) are monitored on a periodic basis, one or more operators are sometimes provided with a fixed list of machines from which vibration measurements are to be taken at particular dates or time intervals. Such a list is referred to as a “route” and is generally fixed for a particular location. In other words, the route has the operator check specific machines on fixed days and repeats the process on a fixed periodic basis. For example, an operator may take sensor data from a particular machine every other Tuesday or on a particular day of the month. Accordingly, a prognostication system (1) may provide a manual-electronic testing of machines perhaps that an operator may manually bring a testing device or the like to a particular machine and may electronically test the machines with a device or the like.

Embodiments of the present invention may provide a prognostication system (1) such as a high efficiency machine test prognosticative routing system and methods thereof. A data input (2) such as an interconnected rotational motive apparatus valued information indicia input may be utilized and may even be received from a plurality of interconnected rotational motive apparatuses. Receiving of input may include but is not limited to periodically receiving, continuously receiving, remotely receiving, wirelessly receiving, downloading, receiving said valued information indicia via a connection, any combination thereof, or the like. A programmed processor may be utilized to perhaps provide schematically sequencing recommended rotational motive apparatus condition assays perhaps for a plurality of interconnected machines. As such, a prognosticated result element (4) may be a sequenced rotational motive apparatus condition assay schematic recommendation. Processed data or even forecast values or the like can be used to create an ad-hoc measurement list (e.g., an ad-hoc sequenced rotational motive apparatus condition assay schematic recommendation) such as a dynamic route list which may ensure that the machines expected to have one or more sensors or otherwise reach an alarm level within a particular time period (e.g., fourteen days) are checked first and/or more frequently. Other machines in which an alarm level may not be expected for a more substantial time period (e.g., three months) may be checked on a less frequent basis. The route list may be a changeable dynamic route list in that it may be constantly updated based on the most recent data received by the measuring device and perhaps by tracking the difference in data such as vibrations and/or frequencies. A route list may be a cost effective recommendation so as to cost effectively recommend machine testing and maintenance. A minimized recommendation may be provided perhaps to reduce (e g., minimizing) the number of machines to be assayed perhaps as a cost effective option.

Embodiments of the present invention may provide that a sequenced rotational motive apparatus condition assay schematic recommendation may give a hierarchical recommendation or a recommended sequence order for machine testing perhaps for hierarchically sequencing or even recommendation of testing of interconnected machines or even for planning a machine route of machine testing perhaps for user evaluation. A sequenced rotational motive apparatus condition assay schematic recommendation may be responsive to a machine condition forecaster or the like, as further understood by the discussion herein.

A prognostication system or even hand-held measuring units may be programmable to vary the number of prior measurement events stored in the device's memory and to vary or adjust the forecasting technique used for particular sensors and/or machines. When a user collects a new measurement in the field, the appropriate forecasting function with a new data point may be computed and the value ‘D’ may be shown to the technician. The number of measurements held by the device may be programmable and may be downloaded to the unit by the software it connects to. The particular forecast expression may also be programmable and downloaded to the device.

A prognosticated result element such as a forecast value may be used to vary the types of measurements or measurement techniques used on a particular machine. Multiple sensor analysis or even variably sensing may enhance the prognostication of the machine conditions. Therefore, embodiments of the present invention may provide variably receiving valued information indicia perhaps as a variable rotational motive apparatus valued indicia input or the like. Specifically, a processor, device, or even a hand-held device may be programmed to collect different, more specific, or even better data when one or more sensors determine that a particular machine may exceed an alarm level within a particular time period. Based on a user programmable limit, the value ‘D’ may be used to control the on/off state of a set of measurements. The intent may be to collect very specific which could be better data when the alarm horizon may be shorter than the set limit. The measurements could be preloaded into the device and thereby collected immediately as soon as the threshold may be exceeded. Alternatively, the evaluation of ‘D’ may be done in the software and the software may construct a route of all measurements that need to be collected only when ‘D’ is exceeding the threshold.

A device including but not limited to a hand-held device or even central processor may be programmed to calculate and display summaries or even a future outage cost of a machine or plurality of machines, which can be utilized to modify the dynamic route list or other results or the like. Such outage costs may be calculated for an entire plant having multiple machines and may provide summary information showing if the outage could be significant or not. A measurement forecast ‘D’ for a machine may include values of criticality and cost of inoperation perhaps combined to express future outage cost of such machine or machines. This can be extended across the plant to derive future outage costs for the entire plant. Summaries may also include entire machine forecast values which may include the costs considered, value, expenses, or the like. Accordingly, embodiments of the present invention may provide a prognosticated result element (4) which may be a report that may include but is not limited to values of criticality, cost of inoperation, future outage cost of machine, outage costs for an interconnected system, outage costs for a plant, costs for machine failure, estimated costs, costs considered, value, expenses, any combination thereof, or the like.

In embodiments, the present invention may provide for an immediate indicator to provide real-time (or near real-time) prognostication of a machine. For example, an immediate indicator of a rotational motive apparatus condition assay agenda recommendation may be provided. As such, in embodiments, a display (5) may be an immediate indicator or even an alert system. An alert system may be used to perhaps alert a user as to when new data has been received, when a forecast is getting near an alarm threshold, or the like.

The various embodiments of the present invention may include a data storage module that can receive and store data or other information; a data analyzer module which may be in communication with the data storage module; and perhaps a computer or computational device of some type. The data storage module may be any nonvolatile or even volatile memory storage device, such as a hard drive, magnetic tape, etc. The data storage module may have one or more databases for storing data. A computer or device may have a programmable or even application specific processor that may be in communication with a data storage module and a data analyzer module. A central processor may coordinate communications between a data analyzer module and a data storage module, and may generally aid in the processing of data. A data analyzer module may consist of one or more software/hardware or firmware components for analyzing data to produce visual displays of the data or results which may assist machine maintenance personnel in identifying and correcting or transforming machine operational problems or defects or even monitoring tasks or sequences.

It should be understood that the structure of a system (1) as depicted in FIG. 3 is only exemplary of one general system in accordance with the invention. More particularly, it will be apparent to a person of ordinary skill in the relevant technology that that the system may use various modules, software, subroutines, programs, sensors, techniques, or the like to accomplish the prognostication system. Each of the calculations, transformations, results, displays and the like as discussed herein may be embodied in a software program, subroutines, programs, and the like.

As can be easily understood from the foregoing, the basic concepts of the present invention may be embodied in a variety of ways. It involves both prognosticating techniques as well as devices to accomplish the appropriate prognostication. In this application, the prognosticating techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “transformation” should be understood to encompass disclosure of the act of “transforming”—whether explicitly discussed or not—and, conversely, were there effectively disclosure of the act of “transforming”, such a disclosure should be understood to encompass disclosure of a “transformation” and even a “means for “transforming.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the prognostication devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming or other electronic automation, the applicant(s) should be understood to have support to claim and make a statement of invention to at least: xv) processes performed with the aid of or on a computer as described throughout the above discussion, xvi) a programmable apparatus as described throughout the above discussion, xvii) a computer readable memory encoded with data to direct a computer comprising means or elements which function as described throughout the above discussion, xviii) a computer configured as herein disclosed and described, xix) individual or combined subroutines and programs as herein disclosed and described, xx) a carrier medium carrying computer readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) the related methods disclosed and described, xxvi) similar, equivalent, and even implicit variations of each of these systems and methods, xxvii) those alternative designs which accomplish each of the functions shown as are disclosed and described, xxviii) those alternative designs and methods which accomplish each of the functions shown as are implicit to accomplish that which is disclosed and described, xxix) each feature, component, and step shown as separate and independent inventions, and xxx) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1-66. (canceled)

67. A prognosticative high efficiency scheduling system of machine testing comprising:
a rotational motive apparatus valued information indicia input received from a rotational motive apparatus;
a programmed valued information indicia transformation processor; and
a rotational motive apparatus condition assay agenda recommendation responsive to said valued information indicia.

68. A prognosticative high efficiency scheduling system of machine testing according to claim 67 wherein said rotational motive apparatus condition assay agenda recommendation comprises a machine testing frequency recommendation.

69. A prognosticative high efficiency scheduling system of machine testing according to claim 68 wherein said machine testing frequency recommendation is selected from a group consisting of a time, a number of days, an increased frequency of testing, decreased frequency of testing, and any combination thereof.

70-71. (canceled)

72. A prognosticative high efficiency scheduling system of machine testing according to claim 67 wherein said rotational motive apparatus condition assay agenda recommendation is responsive to a machine alarm level.

73. A prognosticative high efficiency scheduling system of machine testing according to claim 72 wherein said machine alarm level is selected from a group consisting of a predetermined maximum level for a machine performance characteristic; a machine threshold; a machine future performance level; machine maintenance; machine failure; decrease in machine function; unacceptable risk level; and any combination thereof.

74-75. (canceled)

76. A prognosticative high efficiency scheduling system of machine testing according to claim 67 wherein said programmed valued information indicia transformation processor comprises a data transformation element selected from a group consisting of: statistical modeling technique; trend plot; linear display; curve fit; linear curve fit; exponential curve fit; empirical models; polynominal models; transformation into derived data; technical analysis; stochastic estimator; SAR; PSAR; output of statistic models; CUSUM function; smooth data; bringing out key artifacts; indicator script; trailing stop; sequential analysis techniques; machine specific trending; algorithms; trends; compression; and any combination thereof.

77. A prognosticative high efficiency scheduling system of machine testing according to claim 67 wherein said programmed valued information indicia transformation processor comprises a machine condition determinator.

78. A prognosticative high efficiency scheduling system of machine testing according to claim 77 wherein said machine condition determinator comprises a measurement forecast.

79. A prognosticative high efficiency scheduling system of machine testing according to claim 78 wherein said rotational motive apparatus condition assay agenda recommendation is responsive to said measurement forecast.

80-83. (canceled)

84. A high efficiency machine test prognosticative routing system comprising:
an interconnected rotational motive apparatus valued information indicia input received from a plurality of interconnected rotational motive apparatuses;
a programmed valued information indicia transformation processor; and
a sequenced rotational motive apparatus condition assay schematic recommendation for said plurality of interconnected rotational motive apparatuses.

85. A high efficiency machine prognosticative routing system according to claim 84 wherein said sequenced rotational motive apparatus condition assay schematic recommendation comprises a hierarchical recommendation order for machine testing.

86. A high efficiency machine prognosticative routing system according to claim 84 wherein said sequenced rotational motive apparatus condition assay schematic recommendation comprises a machine route for machine testing.

87-96. (canceled)

97. A high efficiency machine prognosticative routing system according to claim 84 wherein said sequenced rotational motive apparatus condition assay schematic recommendation comprises an ad-hoc sequenced rotational motive apparatus condition assay schematic recommendation.

98. A high efficiency machine prognosticative routing system according to claim 84 wherein said sequenced rotational motive apparatus condition assay schematic recommendation comprises a dynamic route list for machine testing.

99-102. (canceled)

103. A high efficiency machine prognosticative valuation system comprising:
an interconnected rotational motive apparatus valued information indicia input received from a plurality of interconnected rotational motive apparatuses;
an extrinsic influential information input;
a data comparable programmed processor configured to compare said interconnected rotational motive apparatus valued information indicia input with said extrinsic influential information input; and
a machine maintenance exigency prognosticator for each of said interconnected rotational motive apparatus.

104. A high efficiency machine prognosticative valuation system according to claim 103 wherein said extrinsically influential information is selected from a group consisting of: interconnected system information, factory information, an interconnected rotational motive apparatus effect information, an individual rotational motive apparatus effect information, failure effect information, time period information, calendar information, scheduling information, operator knowledge information, operator timeframe information, conservative threshold information, traditional threshold information, machine supplier information, machine type information, weather information, black out information, ability to check machines information, vacation information, ability to maintain a machine information, system value information, assembly line information, supply line information, entire factory information, entire process information, and any combination thereof.

105. A high efficiency machine prognosticative valuation system according to claim 103 wherein said machine maintenance exigency prognosticator comprises a machine failure impact evaluator responsive to extrinsic influential information.

106-119. (canceled)

120. A system according to claim 67 wherein said rotational motive apparatus valued information indicia input received from said rotational motive apparatus comprises rotational motive apparatus valued information indicia input received on a device selected from a group consisting of a portable device, a remote device, a hand-held device, a processor, a specialized program downloaded onto a mobile device, a particularly configured computer, a specialized computer, a central processor, a central computer, a remote computer, a software system, a microlog, a marlin, and a pen.

121. A system according to claim 67 and further comprising a manual-electronic test of said rotational motive apparatus.

122-128. (canceled)

129. A system according to claim 67 wherein said rotational motive apparatus is selected from a group consisting of rotating pump, rotating electric motor, compressor, and rotating fan.
